(19) United States
(12) Patent Application Publication
(10) Pub. No.: US 2005/0049883 A1
(43) Pub. Date: Mar. 3, 2005

(54) Facilitating the design specification and ordering from a manufacturer of a particular display product

(75) Inventors: Michael L. Boroson, Rochester, NY (US); Andrea S. Rivers, Bloomfield, NY (US); Roger A. Braden, Rochester, NY (US); Lee W. Tutt, Webster, NY (US)

Correspondence Address: Thomas H. Close;Patent Legal Staff, Eastman Kodak Company, 343 State Street, Rochester, NY, 14650-2201, US

(73) Assignee: Eastman Kodak Company

(21) Appl. No.: 10/647,399

(22) Filed: Aug. 25, 2003

(51) Int. Cl. G06F 17/60

(52) U.S. Cl. 705/1

(57) ABSTRACT

A method of facilitating the design specification and ordering from a manufacturer of a particular display product, which is desired by a product designer, includes the product designer providing design information for a particular desired display product to a service provider; one or more display product manufacturers providing manufacturing information including current manufacturing parametric data; the service provider analyzing the design information and, based upon current manufacturing information received from one or more display product manufacturers, providing suggested design changes or design approval; and the product designer providing a payment to the service provider for services rendered.

### CROSS REFERENCE TO RELATED APPLICATIONS

Reference is made to commonly assigned U.S. patent application Ser. No. 10/021,410 filed Dec. 12, 2001 by Bradley A. Phillips et al., entitled “Apparatus for Permitting Transfer of Organic Material From a Donor to Form a Layer in an OLED Device”, and commonly assigned U.S. patent application Ser. No. ______ filed ______ by Andrea S. Rivers et al., entitled “______”, the disclosures of which are herein incorporated by reference.

### FIELD OF THE INVENTION

The present invention relates to a system for and method of making display product design and manufacturing more cost efficient by optimizing the design data management process. More specifically, the invention is a system for and method of providing design analysis and data conversion based on real-world manufacturing capabilities in a networked computer application that is accessible to both display product designers and manufacturers. A number of example applications of this system are disclosed.

### BACKGROUND OF THE INVENTION

As the use and demand of display products, in particular OLED displays, increases, the need for effective manufacturing of display product designs also increases. As the computer industry has continued to expand over the last several decades, techniques and tools for the design and assembly of electronic products made in high volume have become more automated. Conventionally, during the design stage of electronic products, a number of computer-aided design (CAD) tools can be used to assist in the electrical and mechanical design of the product. Once the design is complete, a number of computer-aided manufacturing (CAM) tools and robots are generally employed in the manufacture of the product.

A widely understood problem in using CAD and CAM tools to create a finished product is that the data stored in and used by the CAD systems is not the same data that must be stored in or used by the CAM and/or assembly systems. There is substantial design-related data used in the CAD system that is unnecessary for the manufacturing of the product, and there is also data that is critical to the assembly of the product that is not used or generated by the CAD system. In addition, data and numerical formats, reference axes, fiducial marks, and the like, are often different in the CAD system than in the CAM/factory automation system. Older conventional methods have addressed these problems by transferring data between the CAD systems and the manufacturing operation via a hard copy that has been interpreted and annotated by a human. The CAD system produces hard copy drawings of the product to be built and then those drawings are given to the manufacturing engineers. The manufacturing engineers, looking at the CAD drawings, ignore the details extraneous to building the product and add other information. If automated equipment is used in the manufacturing line, the automated equipment is generally programmed manually by a technician reading the CAD drawings. The more advanced CAD/CAM systems automatically convert CAD data to CAM data to generate manufacturing automation programming. These conversion systems are typically based on the ideal performance of the targeted automation equipment and do not take into account real-world process limitations.

For designers and marketers of any product, the product design processes required to meet manufacturability constraints is costly. A range of processes for submitting product designs to manufacturers exists. The most rudimentary processes involve customers submitting paper specifications for a product that meets their specifications to manufacturers, who subsequently compare submitted product specifications to the rules regarding what can actually be made with the equipment the manufacturer has. Modern design processes utilize computerized design rule check (DRC) programs to validate product specifications before sending them to manufacturers.

However, regardless of where in the range of these processes that any particular customer-manufacturer relationship falls, a variety of real-world limitations are seldom included in these known design rules. These real-world limitations often require product designers to modify and re-submit specifications to meet rules that they did not know exist, or can even render their designs unmanufacturable. In addition, a cost of manufacture savings may be possible if a customer were able to obtain information, which enabled them to choose a manufacturing site with the appropriate level of manufacturing capability. Thus, a need exists to make the process of submitting realistic product designs more cost efficient.

For product manufacturers, the process of reviewing specifications from product designers is costly. Many designs are submitted and reviewed that do not meet basic criteria, including incomplete submissions and submissions for products that require unavailable manufacturing equipment. The process of reviewing product specifications and requesting modifications from product designers is costly. Thus, a need exists to make the process of reviewing product specifications more cost efficient.

Another barrier to automating the transfer of CAD files to CAM systems is keeping the capability data and design rules current. This data changes as a result of: (1) changes on the design side related to product updates; (2) changes on the manufacturer side related to equipment age, processing techniques, supplies, etc.; and 3) basic changes to the technology. If both customer and manufacturer are not using the same data set, expensive inefficiencies are introduced to the process. Therefore, a need exists to keep design and manufacturing rules synchronized between product designers and manufacturers.

European Patent No. 1 003 087 A1 describes a method whereby the data to be transferred between the design system (CAD) and the manufacturing system (CAM) includes relative information as to the geometry of the object to be manufactured. The method defines certain parts at least of the object's geometry by: accessing a first library of the design system (CAD); selecting at least a pre-defined article in the first library; importing references for the article into the definition file of the object in the design system; transferring from the definition file from the design system (CAD) to the manufacturing system by identifying the article by reference; accessing a second library associated with the manufacturing system and manufacturing data selection as a function of references corresponding to those of the article in the definition file; and importing manufacturing data into the manufacturing file for the object. While this invention creates a database system for design and data conversion rules, it does not provide for the inclusion of machine-specific manufacturing capability data in real time.

### SUMMARY OF THE INVENTION

It is therefore an object of the present invention to make the process of designing manufacturable display products more cost efficient.

It is another object of this invention to make the process of design analysis, such as design rule checking, more effective.

It is yet another object of this invention to keep design and manufacturing data dependencies synchronized between product designers and manufacturers.

It is yet another object of this invention to permit real-time updates to manufacturing capability data.

This object is achieved by a method of facilitating the design specification and ordering from a manufacturer of a particular display product which is desired by a product designer, comprising:
a) the product designer providing design information for a particular desired display product to a service provider;
b) one or more display product manufacturers providing current manufacturing information including current manufacturing parametric data;
c) the service provider analyzing the design information and, based upon current manufacturing information received from one or more display product manufacturers, providing suggested design changes or design approval; and
d) the product designer providing a payment to the service provider for services rendered.

### ADVANTAGES

A service provider as described herein offers several distinct advantages over conventional design data management systems. They include accurate, cost-effective design analysis, by basing the analysis processes on actual performance data, the quality and accuracy of the analysis is greatly improved; real-time updating of critical parameters, the centralized capability database can be updated in real time on a machine-by-machine basis from data provided by manufacturers; and centralized control of critical data, software architecture provides for a centralized control of the capability data, permitting greater security, consistency, and accuracy. In addition, the difficult task of synchronizing design and manufacturing changes is greatly simplified, and centralized control permits for development of revenue generation processes via database and analysis/conversion tool access control.

### BRIEF DESCRIPTION OF THE DRAWINGS

FIG. 1 is a block diagram of a system for facilitating the design specification and ordering from a manufacturer of a particular display product that is desired by a product designer;

FIG. 2 is a block diagram of a system data flow for design data management;

FIG. 3 is a block diagram of a system topology for design data management;

FIG. 4 is a block diagram of a software architecture for design data management;

FIG. 5 is a flow chart showing a method for facilitating the design specification and ordering from a manufacturer of a particular display product that is desired by a product designer;

FIG. 6 is a flow chart showing a method of performing a design rule check; and

FIG. 7 is a flow chart showing an alternate method of performing a design rule check.

### DETAILED DESCRIPTION OF THE INVENTION

The present invention is a system for and method of providing design analysis and data conversion based on real-world manufacturing capabilities in a networked computer application that is accessible to both product designers and manufacturers. A number of example applications of this system are disclosed. The method was developed for and is applicable for a display product design, e.g. an organic light-emitting diode (OLED) product, and manufacturing process in which it is desirable that design information (e.g., a CAD file) be analyzed using product or technology capability parameters to determine if the specified product can be manufactured.

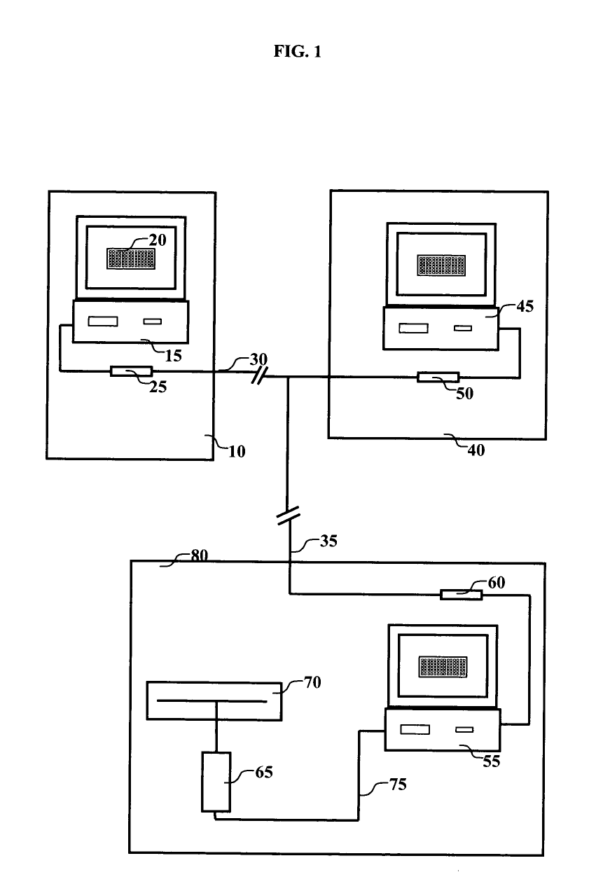

Turning now to FIG. 1, there is shown a block diagram of a system for facilitating the design specification and ordering from a manufacturer of a particular display product that is desired by a product designer. A product designer, located at designer location 10, designs a display to be manufactured in a manufacturing facility, e.g. manufacturing location 80. A service provider is located at service provider location 40. Designer location 10, service provider location 40, and manufacturing location 80 can be the same or different locations, providing that all locations are connected by communication channels, such as channels 30 and 35, which can be e.g. LAN, WAN, ISDN, ATM, PSTN, dial-up connection, intranet, the Internet, or another type of network, and which can be open communication channels or secure channels as needed. Design location 10 includes a workstation or computer 15 that is connected to the network via modem 25. A product designer can create a design 20 of a display device, for example by use of a computer-aided design (CAD) program. The design information can be sent from designer location 10 to the service provider at service provider location 40 via channel 30.

Manufacturing location 80 includes one or more display manufacturing apparatus 70. Display manufacturing apparatus 70 can be e.g. an apparatus such as described in commonly assigned U.S. patent application Ser. No. 10/021,410 filed Dec. 12, 2001 by Bradley A. Phillips et al., entitled “Apparatus for Permitting Transfer of Organic Material From a Donor to Form a Layer in an OLED Device”, the disclosure of which is herein incorporated by reference. A radiation source 65, which can be e.g. a laser, can be used in manufacturing display devices, as described by Phillips et al., and can be controlled and monitored by computer 55 via connection 75. Computer 55 can also be connected to metrology equipment (not shown), which can evaluate the performance of display manufacturing apparatus 70. Computer 55 can be connected via modem 60 and channel 35 to service provider location 40. Current manufacturing information can thus be provided to the service provider at service provider location 40.

Service provider location 40 includes computer 45 that is connected via modem 50 to a network (channels 30 and 35) for communicating with designer location 10 and manufacturing location 80. The service provider can be fully automated, e.g. computer 45, or can include human interaction.

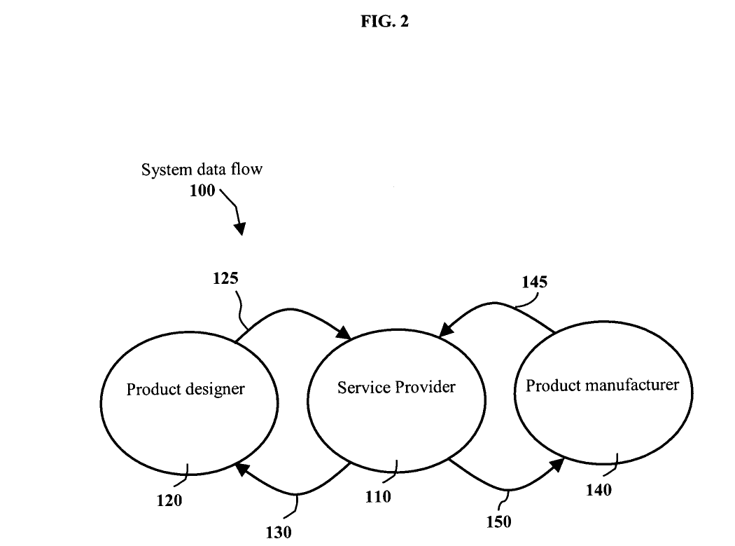

FIG. 2 is a block diagram of a system data flow 100 that includes a product designer 120, a quantity of data 125, a quantity of data 130, a service provider 110 that can be a design management system, a quantity of data 145, a quantity of data 150, and a display product manufacturer 140.

Product designer 120 is an entity that produces design data or design specifications for display products intended to be manufactured. The design data is typically in the form of a CAD file, but can be in any format suitable for automated processing.

Data 125 includes design information for a particular desired display product that a product designer 120 provides to a service provider 110. Such design information can be provided over a secure channel if desired. The design information can include CAD information, design specification files, requirements files, local design analysis results (e.g. design rule checking), proposed outline specification including form fit and function information, or any other data generated by product designer 120 intended for analysis, conversion, or management by service provider 110. The proposed outline specification can include CAD information furnished over a secure channel. By form fit and function information, we mean information sufficient to specify a part, collection of parts, or device that is electrically and mechanically compatible with a design and will perform the desired function.

Data 125 can also include information by which product designer 120 provides a payment to the service provider 110 for services rendered. For example, product designer 120 can specify an account that is to be charged for making payment for services rendered.

Data 145 includes manufacturing information, which can include current manufacturing parametric data. Such manufacturing information can be provided over a secure channel if desired, and can include current cost data, current diagnostic data, current manufacturability data, or combinations thereof. Manufacturing information can further include current equipment classes/types and/or current diagnostic data, diagnostic requests, and current manufacturing availability information. Diagnostic data, collected for a machine or process, is captured while running a diagnostic, as opposed to the manufacture of actual components.

Current manufacturing parametric data can include control charts, process capability data, process yields, and design rule limits. Data 145 includes the current state or most recent state of the manufacturing parametric data, for example performance over the past six months, preferably three months, or most preferably over the past month.

Data 145 can also include information by which product manufacturer 140 provides a payment to the service provider 110, e.g. in the case wherein product manufacturer 140 is selected by product designer 120.

Data 130 includes remote design analysis results, software updates, and any requested or required data from service provider 110. Remote design analysis results include go/no-go decisions, error files, design requirements analysis, supplier capability matching, cost/design tradeoffs, and product performance estimations. Data 130 can also include suggested design changes, suggested manufacturers, cost information, delivery information, display product performance information, or combinations thereof. Data 130 can also include communication by the service provider 110 with product designer 120 to obtain information needed to provide an effective reply to the product designer 120.

Data 150 includes CAM data. Data 150 can also include communication by the service provider 110 with product manufacturer 140 to obtain information needed to provide an effective reply to product designer 120.

Although both FIG. 1 and FIG. 2 show a single manufacturing location 80 and display product manufacturer 140, respectively, it will be understood that the method described herein can also be performed with a plurality of display product manufacturers 140.

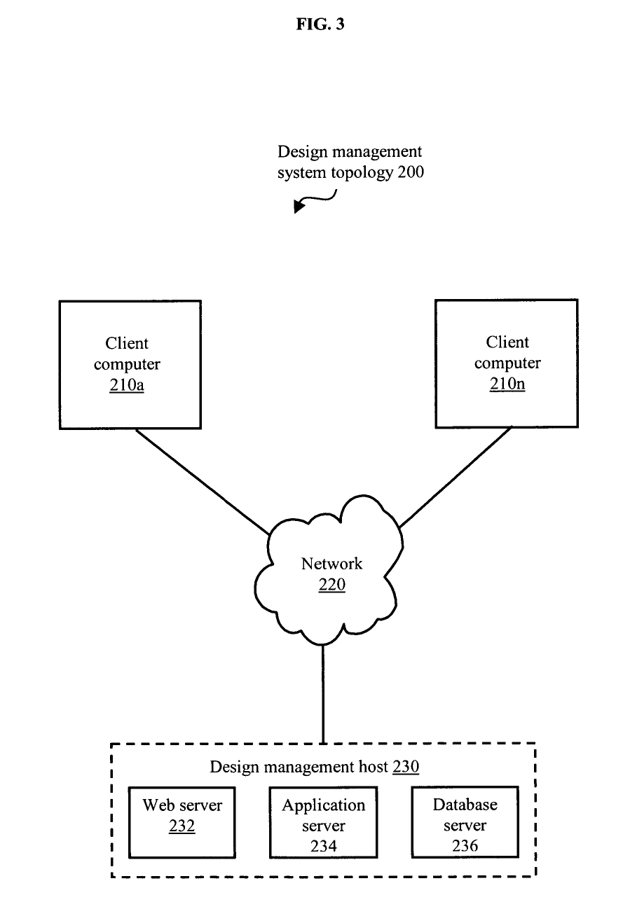

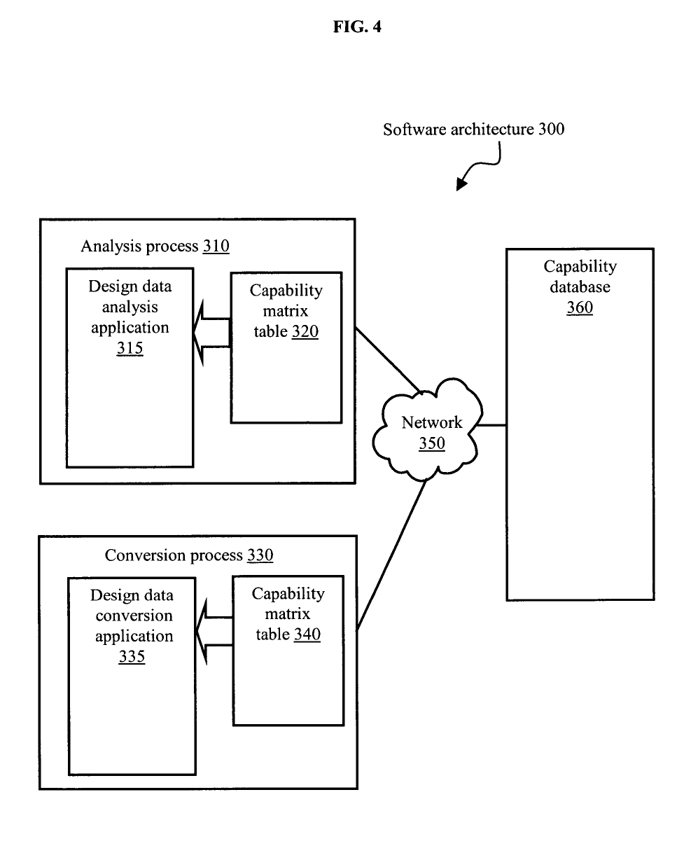

Service provider 110 performs a set of automated processes and associated hardware for processing data transfer and management requests from product designer 120 and product manufacturer 140. Service provider 110 is discussed in more detail in FIG. 3 and FIG. 4.

FIG. 3 is a block diagram of a design management system topology 200, including the elements of a plurality of client computers (210a and 210n), a network 220, and a design management host 230. Design management host 230 further includes a Web server 232, an application server 234, and a database server 236.

Client computers (210a and 210n) are typically personal computers or workstations resident in either product designer 120 or product manufacturer 140. Client computers (210a and 210n) have the ability to transmit and receive data over network 220.

Network 220 is a communications network, such as a LAN, WAN, ISDN, ATM, PSTN dial-up connection, intranet, or the Internet.

Design management host 230 is a hardware system for executing the functions of service provider 110. Design management host 230 can be physically located on one or more servers, according to the specific requirements of design management system topology 200. Design management host 230 can be physically co-located or distributed in any conventional distributed computing architecture.

Web server 232 is a server application that provides World Wide Web services, and can reside on multiple physical servers. Web server 232 handles all HTTP requests from client computers (210a and 210n), and sends requests for data to application server 234 to be displayed on client computers (210a and 210n).

Application server 234 is a server application that provides support for whatever applications are required by design management host 230, and can reside on multiple physical servers. Application server 234 implements a portion of the business logic and rules for design management system topology 200; the remainder of the business logic and rules are implemented by the database system in database server 236. Minimally, application server 234 performs five functions: (1) manages forms for data entry and display; (2) stores attachments; (3) processes e-mail related to the applications; (4) processes queries; and (5) provides a reporting tool.

Database server 236 is a server application that supports and maintains tables or other data structures according to the specific architectural needs of design management system topology 200. Minimally, database server 236 provides a relational database management system (DBMS). Database server 236 maintains and stores a variety of transaction information, which is served back to client computers (210a and 210n) via network 220.

In one specific example, Web server 232, application server 234, and database server 236 are all installed onto one physical server.

In another specific example, Web server 232, application server 234, and database server 236 reside on separate server computers.

In operation, client computers (210a and 210n) input, store, process, and output information in a conventional manner.

In one preferred embodiment, product designer 120 launches Web browser software installed on client computers (210a and 210n). Web browser software displays a user interface comprised of Web pages provided by Web server 232. For example, the user interface is customized for product designers 120 submitting product design information. Product designer 120 can use the user interface to select a CAD file containing product specifications for processing by software resident on application server 234. Product specifications are transmitted from client computers (210a and 210n) across network 220 and are stored in design management host 230. Subsequent processing steps are described below. In another example, instead of inputting a CAD file, customer inputs a structured data file containing all required product parameters.

Service provider 110 provides design analysis and data conversion that takes into account real-world manufacturing limitations and variability. Key to that characteristic is the availability of real-time process capability information.

FIG. 4 is a block diagram of a software architecture 300 for design data management, which provides for a database that tracks common process capability. Software architecture 300 includes an analysis process 310, a conversion process 330, a network 350, and a capability database 360.

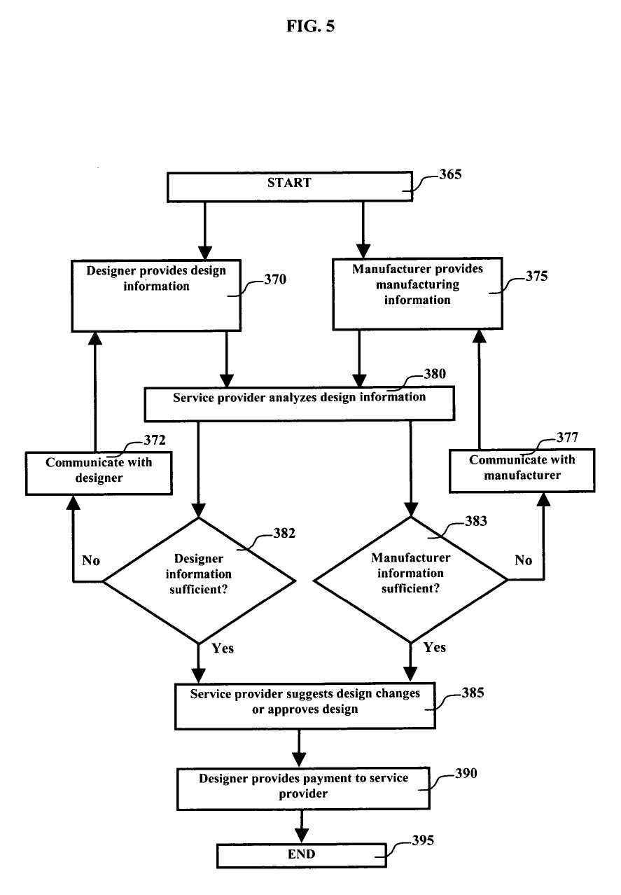

Analysis process 310 further includes a design data analysis application 315 and a capability matrix table 320. In one example (described in detail below in reference to FIG. 4), analysis process 310 is contained within application server 234. In another example (described in detail below in reference to FIG. 5), analysis process 310 is contained within software installed on client computers (210a and 210n).

Conversion process 330 further includes a design data conversion application 335 and a capability matrix table 340.

Network 350 is a data communications network, like network 220 described above.

Capability database 360 is a relational database that accesses parameters for manufacturing and technology capabilities. Capability database 360 is contained within database server 236.

In operation, analysis process 310 receives a request to process some manner of design data (not shown). As part of processing this request, certain manufacturing or technology capability indexes are identified. A request for these capability indexes is sent through network 350, and the capability indexes are used to search capability database 360 and to build capability matrix table 320. Design data analysis application 315 (e.g., a design rule checker) uses capability matrix table 320 to define analysis parameters for processing the design data.

Conversion process 330, design data conversion application 335, and capability matrix table 340 operate in a similar fashion to analysis process 310, design data analysis application 315, and capability matrix table 320, respectively.

Software architecture 300 is independent of the type or locality of the supporting hardware. Analysis process 310, conversion process 330, and capability database 360 can be co-resident on the same computer or resident on separate computers.

In a preferred embodiment, analysis process 310 and conversion process 330 are designed in such a way that they cannot operate without a valid capability matrix table. Validity can be determined in any of a variety of ways, including, but not limited to: date code, cyclic redundancy check (CRC), password protection, or file source.

Turning now to FIG. 5, and also referring to FIG. 2, there is shown a flow chart showing a method for facilitating the design specification and ordering from a manufacturer of a particular display product that is desired by a product designer 120. At the start (step 365), a product designer 120 provides design information via data 125 for a particular desired display product to a service provider 110 (step 370). If desired, the design information can be provided over a secure channel. One or more display product manufacturers 140 provide manufacturing information via data 145 including current manufacturing parametric data to the same service provider 110 (step 375). The manufacturing information can include the data and information described above for data 145. If desired, the manufacturing information can be provided over a secure channel, which can be the same secure channel as used for the design information, or can be a different secure channel. Step 375 can precede, succeed, or be simultaneous with step 370. The service provider 110 then analyzes the design information provided by the product designer 120 (step 380).

If the information provided by product designer 120 is insufficient to provide an effective reply to product designer 120 (step 382), the service provider 110 can optionally communicate with the product designer 120 via data 130 to obtain information needed to provide an effective reply to product designer 120 (step 372). If necessary, the iterative cycle of providing information (step 370), analyzing the information (step 380), and communicating to request further information (step 372) can be repeated.

If the information provided by product manufacturer 140 is insufficient to provide an effective reply to product designer 120 (step 383), the service provider 110 can optionally communicate with the one or more product manufacturers 140 via data 150 to obtain information needed to provide an effective reply to product designer 120 (step 377). If necessary, the iterative cycle of providing information (step 375), analyzing the information (step 380), and communicating to request further information (step 377) can be repeated.

If the provided information is sufficient, there is no need for further communications with the product designer 120 and product manufacturer(s) 140 for the purpose of requesting additional information. Based upon current manufacturing information received from one or more display product manufacturers 140, the service provider 110 provides via data 130 suggested design changes (or design approval, if no changes are necessary) to the product designer 120 (step 385). The service provider 110 can further provide suggested manufacturers based upon the analysis, or cost information, or delivery information, or display product performance information, or combinations thereof. The product designer 120 then provides a payment to the service provider 110 for services rendered (step 390), e.g. product designer 120 can specify in data 125 an account which is to be charged for making payment to service provider 110 for services rendered, after which the process ends (step 395). Additional optional steps that are not shown are also possible. For example, a product manufacturer 140 that is selected by product designer 120 can provide a payment to service provider 110.

The following two figures show in greater detail the process by which service provider 110 analyzes the design information.

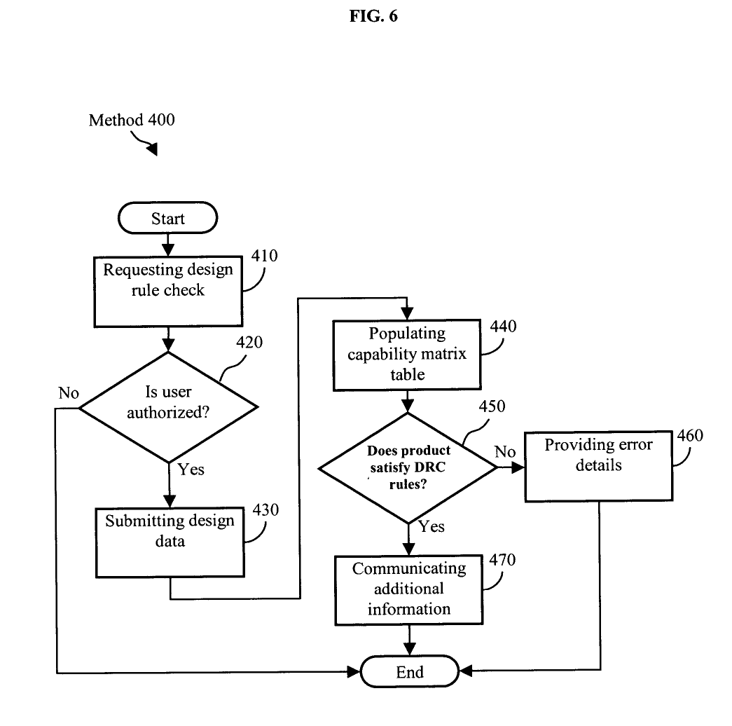

FIG. 6 is a flow chart showing a method 400 of performing a design rule check that is an example of executing analysis process 310. In this particular example, analysis process 310 takes the form of a design rule checker. Method 400 shows a case in which capability matrix table 320 is created “on the fly” for the application, including the steps below.

In step 410, product designer 120 requests access to design rule checking applications from service provider 110.

In decision step 420, a determination is made as to whether a system operator is an authorized user of the systems of service provider 110. In one example, this authentication is done with conventional username and password authentication where a user logon form is transmitted to client computers (210a and 210n) from design management host 230. The combination of username and password is compared to the file of valid usernames and passwords stored in design management host 230. If the username and password combination submitted by the system operator matches a known valid combination in design management host 230, method 400 proceeds to step 430. If the username password combination submitted by system operator cannot be found (e.g., after three attempts), method 400 ends.

In step 430, product designer 120 submits design data for design rule checking to ensure that the product specified can be manufactured. In one example, the product specification file is a CAD file. In another example, the product specification file is a structured data set. The product specification file is transmitted by network 220 and stored by design management host 230, (e.g., in application server 234) for subsequent analysis.

In step 440, capability matrix table 320 is created by database server 236 in design management host 230 and is populated with at least three types of data, namely: (1) current data regarding product design rules; (2) manufacturing equipment machine classes; and (3) performance data regarding the manufacturing equipment of participating manufacturers. In this example, design data analysis application 315 differs from conventional DRC methods in that it incorporates the manufacturing equipment performance data. In one example, after a product design has been submitted, design management host 230 sends request(s) via network 220 to a plurality of client computers (210a and 210n) (of product manufacturers 140) that contain these data sets. In this example, each product manufacturer 140 provides current data regarding one or more of the three types of data described above via client computers (210a and 210n) that is accessible by design management host 230. This data from product manufacturers 140 is stored in capability database 360.

In step 450, the design data submitted in step 430 is analyzed using parameters contained in capability matrix table 320, which was populated in step 440. If the design data satisfy the conditions defined by capability matrix table 320, method 400 proceeds to step 470; if not, method 400 proceeds to step 460.

In step 460, error details regarding product specifications are sent to product designer 120 from design management host 230 via network 220. These error details are generated as a result of running the product design against the design rule checker. The error details that are sent to product designer 120 generally include information to permit product designer 120 to quickly find design errors and plainly identify the action necessary to correct them. In a more specific example, potential errors include issues related to any of the following areas, including but not limited to: DRC compilation, constraint violations, incomplete or incorrect definitions, incompatible device properties, incompatible layer properties, and syntax. Method 400 then ends.

In step 470, additional information regarding product specifications is sent from design management host 230 via network 220. In one example, potential design modifications are sent to product designer 120 to permit designers to consider potential design changes. In another example, design approval is provided to product designer 120 to indicate that the potential design can be manufactured. In another example, a yield analysis is provided to product designer 120 based on the product specified and the capabilities of manufacturers. In yet another example, a set of potential product manufacturers 140 whose equipment is capable of producing the specified product is provided to product designer 120. Method 400 ends.

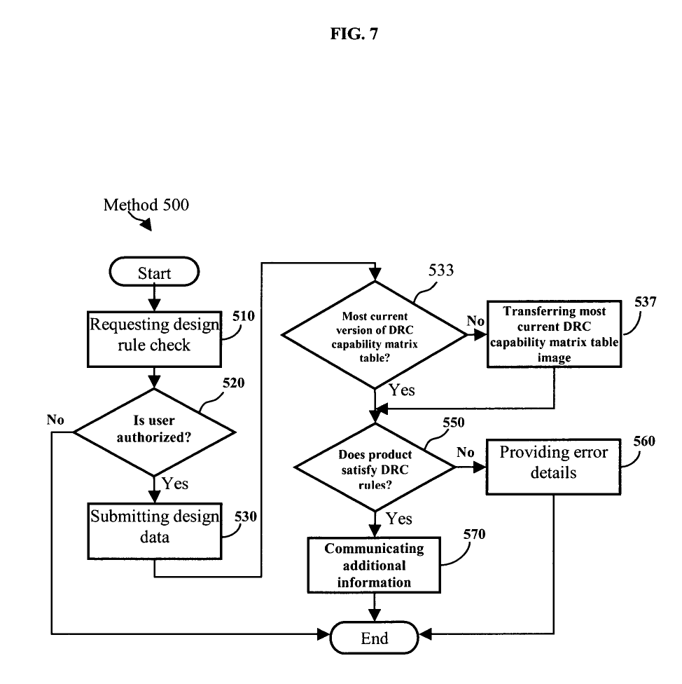

FIG. 7 is a flow chart showing an alternate method 500 of performing a design rule check (an alternative embodiment to method 400), whereby capability matrix table 320 is stored locally within client computers (210a and 210n) for analysis process 310 and the validity of capability matrix table 320 is checked on a run-by-run basis, including the steps below.

In step 510, product designer 120 requests access to design rule checking applications from service provider 110.

In decision step 520, a determination is made as to whether the system operator is an authorized user of the systems of service provider 110. In one example, this authentication is done with conventional username and password authentication where a user logon form is transmitted to client computers (210a and 210n) from design management host 230. The combination of username and password is compared to the file of valid usernames and passwords stored in design management host 230. If the username and password combination submitted by the system operator matches a known valid combination in design management host 230, method 500 proceeds to step 530. If the username password combination submitted by system operator cannot be found (e.g., after three attempts), method 500 ends.

In step 530, product designer 120 submits design data for design rule checking to ensure that the product specified can be manufactured. In one example, the product specification file is a CAD file. In another example, the product specification file is a structured data set. The product specification file is transmitted by network 220 and stored by design management host 230, (e.g., in application server 234) for subsequent analysis.

In decision step 533, the design rule checker queries design management host 230 to determine whether capability matrix table 320 resident within client computers (210a and 210n) is current. If so, method 500 proceeds to step 550. If not, method 500 proceeds to step 537.

In step 537, the most current image of DRC capability matrix table 320 is transferred to analysis process 310 within client computers (210a and 210n) via network 220. This step ensures that the most current design rules and manufacturer information is available when a product design is checked.

In decision step 550, the design data submitted in step 530 is analyzed and compared to DRC capability matrix table 320 populated in step 537. If the design data satisfies the conditions defined by the DRC capability matrix, method 500 proceeds to step 570; if not, method 500 proceeds to step 560.

In step 560, error details regarding product specifications are sent to product designer 120 from design management host 230 via network 220. These error details are generated as a result of running the product design against the design rule checker. The error details that are sent to product designer 120 generally include information to permit product designer 120 to quickly find design errors and plainly identify the action necessary to correct them. In a more specific example, potential errors include issues related to any of the following areas, including but not limited to: DRC compilation, constraint violations, incomplete or incorrect definitions, incompatible device properties, incompatible layer properties, and syntax. Method 500 then ends.

In step 570, additional information regarding product specifications is sent from design management host 230 via network 220. In one example, potential design modifications are sent to product designer 120 to permit designers to consider potential design changes. In another example, design approval is provided to product designer 120 to indicate that the potential design can be manufactured. In another example, a yield analysis is provided to product designer 120 based on the product specified and the capabilities of manufacturers. In yet another example, a set of potential product manufacturers 140 whose equipment is capable of producing the specified product is provided to product designer 120. Method 500 then ends.

Methods 400 and 500 are just two examples of design analysis methods supported by the invention. Similar processes for design data conversion (e.g., converting CAD data to CAM/factory automation data) are supported. For example, generation of raster images for the control of a laser thermal transfer process as described in commonly assigned U.S. patent application Ser. No. ______ filed ______ by Andrea S. Rivers et al., entitled “______”, the disclosure of which is herein incorporated by reference, can be integrated by service provider 110 in such a way that guarantees that only valid and appropriate capability data is used to generate the raster images.

The invention has been described in detail with particular reference to certain preferred embodiments thereof, but it will be understood that variations and modifications can be effected within the spirit and scope of the invention.

### Parts List

10 designer location
15 computer
20 design
25 modem
30 channel
35 channel
40 service provider location
45 computer
50 modem
55 computer
60 modem
65 radiation source
70 display manufacturing apparatus
75 connection
80 manufacturing location
100 system data flow
110 service provider
120 product designer
125 data
130 data
140 display product manufacturer
145 data
150 data
200 design management system topology
210a client computer
210n client computer
220 network
230 design management host

### PARTS LIST (con't)

232 web server
234 application server
236 database server
300 software architecture
310 analysis process
315 design data analysis application
320 capability matrix table
330 conversion process
335 design data conversion application
340 capability matrix table
350 network
360 capability database
365 block
370 block
372 block
375 block
377 block
380 block
382 decision block
383 decision block
385 block
390 block
395 block
400 method
410 block
420 decision block
430 block

### PARTS LIST (con't)

440 block
450 decision block
460 block
470 block
500 method
510 block
520 decision block
530 block
533 decision block
537 block
550 decision block
560 block
570 block

1. A method of facilitating the design specification and ordering from a manufacturer of a particular display product, which is desired by a product designer, comprising:
a) the product designer providing design information for a particular desired display product to a service provider;
b) one or more display product manufacturers providing manufacturing information including current manufacturing parametric data;
c) the service provider analyzing the design information and, based upon current manufacturing information received from one or more display product manufacturers, providing suggested design changes or design approval; and
d) the product designer providing a payment to the service provider for services rendered.

2. The method of claim 1 wherein the manufacturing information further includes current cost data, or current diagnostic data, or current manufacturing availability information, or current equipment classes/types, or combinations thereof.

3. The method of claim 1 wherein in step c) the service provider further provides suggested manufacturers, or cost information, or delivery information, or display product performance information, or combinations thereof.

4. A method of facilitating the design specification and ordering from a manufacturer of a particular display product, which is desired by a product designer, comprising:
a) the product designer providing over a secure channel design information for a particular desired display product to a service provider;
b) one or more display product manufacturers providing, over the same or a different secure channel, manufacturing information including current manufacturing parametric data;
c) the service provider communicating with one or more manufacturers to obtain information needed to provide an effective reply to the product designer;
d) the service provider analyzing the design information and, based upon manufacturing information received from one or more display product manufacturers, providing suggested design changes or design approval; and
e) the product designer providing a payment to the service provider for services rendered.

5. The method of claim 4 wherein the manufacturing information further includes current cost data, or current diagnostic data, or current manufacturing availability information, or current equipment classes/types, or combinations thereof.

6. The method of claim 4 wherein in step d) the service provider further provides suggested manufacturers, or cost information, or delivery information, or display product performance information, or combinations thereof.

7. A method of facilitating the design specification and ordering from a manufacturer of a particular display product, which is desired by a product designer, comprising:
a) the product designer providing over a secure channel design information for a particular desired display product to a service provider;
b) one or more display product manufacturers providing, over the same or a different secure channel, manufacturing information including current manufacturing parametric data;
c) the service provider communicating with one or more manufacturers and the product designer to obtain information needed to provide an effective reply to the product designer;
d) the service provider analyzing the design information and, based upon manufacturing information received from one or more display product manufacturers, providing suggested design changes or design approval; and
e) the product designer providing a payment to the service provider for services rendered.

8. The method of claim 7 wherein the manufacturing information further includes current cost data, or current diagnostic data, or current manufacturing availability information, or current equipment classes/types, or combinations thereof.

9. The method of claim 7 wherein in step d) the service provider further provides suggested manufacturers, or cost information, or delivery information, or display product performance information, or combinations thereof.

10. A method of facilitating the design specification and ordering from a manufacturer of a particular display product, which is desired by a product designer, comprising:
a) the product designer providing over a secure channel design information including proposed outline specification including form fit and function information for a particular desired display product to a service provider;
b) one or more display product manufacturers providing, over the same or a different secure channel, manufacturing information including current manufacturing parametric data, such manufacturing information further including current cost data, current diagnostic data, current manufacturing availability information, and current equipment classes/types;
c) the service provider communicating with one or more manufacturers to obtain information needed to provide an effective reply to the product designer;
d) the service provider analyzing the design information and, based upon current manufacturing information received from one or more display product manufacturers, providing suggested design changes or design approval, and suggested manufacturers; cost information, or delivery information, or display product performance information, or combinations thereof; and
e) the product designer providing a payment to the service provider for services rendered.

11. The method of claim 10 wherein the product designer specifies an account which is to be charged for making payment for services rendered.

12. The method of claim 10 wherein the manufacturer, selected by the product designer, provides a payment to the service provider.

13. The method of claim 10 wherein the proposed outline specification includes CAD information furnished over the secure channel.

14. A method of facilitating the design specification and ordering from a manufacturer of a particular display product, which is desired by a product designer, comprising:
a) the product designer providing over a secure channel design information including proposed outline specification including CAD information for a particular desired display product to a service provider;
b) one or more display product manufacturers providing, over the same or a different secure channel, manufacturing information including current manufacturing parametric data, such manufacturing information further including current cost data, current diagnostic data, current manufacturing availability information, or current equipment classes/types;
c) the service provider communicating with one or more manufacturers to obtain information needed to provide an effective reply to the product designer;
d) the service provider analyzing the design information and, based upon current manufacturing information received from one or more display product manufacturers, providing suggested design changes or design approval, and suggested cost information, delivery information, or display product performance information; and
e) the product designer providing a payment to the service provider for services rendered.

15. The method of claim 14 wherein the product designer specifies an account which is to be charged for making payment for services rendered.

16. The method of claim 14 wherein the manufacturer, selected by the product designer, provides a payment to the service provider.

17. A method of facilitating the design specification and ordering from a manufacturer of a particular display product, which is desired by a product designer, comprising:
a) the product designer providing over a secure channel design information including proposed outline specification including CAD information for a particular desired display product to a service provider;
b) a plurality of display product manufacturers providing, over the same or a different secure channel, manufacturing information including current manufacturing parametric data, such manufacturing information further including current cost data, current diagnostic data, current manufacturing availability information, or current equipment classes/types;
c) the service provider communicating with at least one of the plurality of one or more manufacturers to obtain information needed to provide an effective reply to the product designer;
d) the service provider analyzing the design information and, based upon current manufacturing information received from the display product manufacturers, providing suggested design changes or design approval, and cost information, delivery information, and display product performance information; and
e) the product designer providing a payment to the service provider for services rendered.
